(19) United States
(12) Patent Application Publication
(10) Pub. No.: US 2025/0316817 A1
(43) Pub. Date: Oct. 9, 2025

(54) Cell separating element with integrated structural pattern, as well as battery module with such a cell separating element

(71) Applicants: AUDI AG, Ingolstadt (DE); Volkswagen Aktiengesellschaft, Wolfsburg (DE)

(72) Inventors: Markus Gretzer, Eichstätt (DE); Jan-Philipp Weberpals, Abstat (DE); Johann Hesse, Augsburg (DE); Markus Thurmeier, Adlkofen (DE); Nicole Kässmann, Gaimersheim (DE); Christian Gert VOIGT, Usingen (DE); Jürgen Gerbrand, Kirchberg an der Murr (DE); Michael Ernst, Wüstenrot (DE); Özgür Aktas, Salzgitter (DE); Stephan Kohlitz, Wolfsburg (DE); Thorsten Gläsner, Wolfsburg (DE)

(73) Assignees: AUDI AG, Ingolstadt (DE); Volkswagen Aktiengesellschaft, Wolfsburg (DE)

(21) Appl. No.: 19/170,689

(22) Filed: Apr. 4, 2025

(30) Foreign Application Priority Data
Apr. 5, 2024 (DE) 10 2024 109 572.5

(51) Int. Cl. H01M 50/242; H01M 10/613; H01M 10/6557; H01M 10/658; H01M 50/204; H01M 50/291

(52) U.S. Cl. CPC H01M 50/242; H01M 10/613; H01M 10/6557; H01M 10/658; H01M 50/291; H01M 50/204

(57) ABSTRACT

A cell separating element for thermally shielding two battery cells and for arrangement between the two battery cells, of a battery, may include a first wall and a second wall opposing it, between which a cavity filled or fillable with a fluid is formed, to provide a pad filled or fillable with the fluid. In an example, the walls may be shell-shaped. At least the first wall may include an embossed, depressed structural pattern with at least one embossed, depressed structural element. The structural pattern, when the pad is compressed such that the at least one structural element has contact with an inner side of the second wall adjoining to the cavity, is elastically deformable and/or plastically deformable such that a cavity volume of the cavity increases by a plastic deformation of the structural pattern.

### CROSS-REFERENCE TO RELATED APPLICATIONS

This application claims the priority benefit of German Patent Application No. 10 2024 109 572.5 filed on Apr. 5, 2024, which is incorporated by reference herein in its entirety.

### BACKGROUND

### 1. Field

Examples of an invention relate to a cell separating element for thermally shielding two battery cells and for an arrangement between the two battery cells of a battery. In an example, the cell separating element comprises a first wall and a second wall opposing the first wall, between which a cavity filled or fillable with a fluid is formed, whereby a pad filled or fillable with the fluid is provided. Furthermore, the first and the second wall are flexibly configured such that a thickness of the pad is variable from the outside upon force application to the pad, wherein at least the first wall comprises an embossed, depressed structural pattern with at least one embossed, depressed structural element. Furthermore, the examples of the invention also relate to a battery module with such a cell separating element.

### 2. Description of the Related Art

In high-voltage batteries of electrically operated vehicles, lithium-ion cells in different pack forms, like round cells, prismatic cells, also called cans, or pouch cells, are often predominantly used. Often, cell separating elements are positioned between the cells to take over various tasks in combination with the cell. These tasks for example include the so-called swelling compensation: By electrochemical processes, the volume of the active material in the foil wrap or foil stack of a battery cell increases. This volume increase is referred to as swelling. A defined pressure on the cells by the cell separating element is advantageous to allow controlled swelling of the cells. Unrestrained swelling as well as completely suppressed swelling result in a reduced lifetime. A further function relates to the so-called thermal propagation in case of a thermal runaway of a battery cell. Therein, it is advantageous if cell separating elements are installed between the cells, which provide a thermal insulation for example in the manner that a runaway cell is thermally insulated as far as the adjacent cells do not also catch fire or get in thermal runaway. A further function can also be tempering the cell. Basically, cells can be tempered via thermal connection to a heating and/or cooling circuit to satisfy the full functionality and the lifetime requirements. The thermal connection of the cell can be effected via the cell bottom and/or cell lid or via cell separating elements.

In the previous types of construction of cell separating elements, the above described functions are to be achieved by the employment of multiple components or cannot be implemented in the sought peculiarity. Thereby, a partially severely increased material usage is required. This adversely affects the required installation space, the weight, the manufacturing and mounting effort and the arising material cost.

Therefore, it would be desirable to be able to integrate as many of the above mentioned functions as possible in a cell separating element in as efficient and installation space saving manner as possible. Within the scope of the examples of the present invention, in particular, the focus is to be especially on providing swelling compensation characteristics as good as possible as well as characteristics for preventing or delaying a thermal propagation as beneficial as possible.

DE 11 2011 103 338 T5 describes a heat exchanger for using with two battery modules, wherein each of the battery modules includes at least one battery cell, which is accommodated in a rigid container, wherein the heat exchanger defines an inner fluid passage for a heat exchanger fluid and comprises at least one compliant area, which is formed such that it is compressible to facilitate the thermal contact between the heat exchanger and the two battery modules.

DE 10 2013 021 312 A1 describes a battery with individual cells, a tempering device and heat conducting elements, wherein a heat conducting element thermally couples an individual cell to the tempering device. The heat conducting element is formed of two halves enclosing a cavity, wherein at least one of the halves forms a full-surface spring element, the surface of which spaced from the respectively other half corresponds to at least a surface of a flat side of an electrode foil arrangement, and wherein a spring force generated by the spring element acts substantially perpendicularly to the flat side of the electrode foil arrangement.

DE 10 2019 130 497 A1 describes a separating device for a battery module, which includes two separating elements congruent to each other and arranged on each other of a heat conductive material, which enclose a chamber between them, wherein the separating elements comprise embossments corresponding to each other for forming the chamber, which extend away from each other, wherein the embossments are arranged opposing each other and divide the chamber into multiple chamber areas. The stiffness of the separating elements can be increased by the embossments, whereby the respective separating elements and the separating device can be particularly robustly and stably configured.

### SUMMARY

An example object of the examples of the present invention may be to provide a cell separating element and a battery module, which allow providing a cell separating element with characteristics as good as possible for swelling compensation and with respect to a thermal propagation, and which can additionally be manufactured as efficiently as possible and with individual parts as few as possible.

The example object may be solved by a cell separating element and a battery module with the features according to the respective independent claims. Advantageous configurations of the examples of the invention are the subject matter of the dependent claims, the description as well as the figures.

A cell separating element according to the examples of the invention for thermally shielding two battery cells and for arrangement between the two battery cells of a battery comprises a shell-shaped first wall and a shell-shaped second wall opposing it, between which a cavity filled or fillable with a fluid is formed, whereby a pad filled or fillable with the fluid is provided, wherein the first and the second wall are flexibly formed such that a thickness of the pad is variable from the outside upon force application to the pad, and wherein at least the first wall comprises an embossed depressed structural pattern with at least one embossed, depressed structural element. Therein, when the pad is compressed such that the at least one structural element has contact with an inner side of the second wall adjoining to the cavity, the structural pattern is elastically deformable and/or plastically deformable such that a cavity volume of the cavity increases by a plastic deformation of the structural pattern.

In particular in a state filled with the fluid, the pad offers particularly advantageous swelling compensation characteristics, which is thereby compliant, in particular elastically compliant, and can oppose a certain counterpressure to the cells. This very advantageously affects the lifetime and performance of the battery cells. In addition, by the fluid located in the cavity, for example a gas, or the fluid fillable into the cavity, a very good thermal insulation can be advantageously provided, which is very advantageous especially for opposing to a thermal propagation in case of thermal runaway of a battery cell. The cavity can also be configured capable of being passed by the fluid, whereby an additional active cooling can be provided. These advantageous characteristics can now be additionally reinforced or supplemented by the structural pattern. This is based on the realization that not only the stiffness can be increased by such a structural pattern, but different deformation characteristics, e.g. stiff and non-deformable, plastically deformable and/or elastically deformable, can be provided by a structural pattern. These characteristics can be specifically employed and used to optimize the swelling compensation characteristics or also thermal characteristics and other characteristics of the cell separating element. By the embossed structural pattern, a full-surface contact between the inner sides of the two walls can be avoided on the one hand in case of a compression of the pad, for example by swelling forces of the cells acting on the pad on both sides. A full-surface contact in turn would entail a very good thermally conductive connection between the two walls, which is disadvantageous especially in case of thermal runaway of a battery cell. By the at least one structural element, such a full-surface contact can be advantageously avoided even in case of very severe compression of the pad. In addition, the at least one structural element can for example also act as a spring element by its elastically deformable characteristics, namely exactly when the at least one structural element has contact with the second wall. In addition to e.g. gas resilience, which can be realized by the fluid located in the cavity, if a gas is used as the fluid, an additional elastic counterforce e.g. by some kind of sheet resilience can be opposed to the compression of the pad, as soon as the at least one structural element comes into contact with the opposing second wall. This also aggravates full-surface flattening of the pad by very great swelling forces. By the elastic characteristics, the structural pattern still remains flexible and adaptable especially in cyclic swelling and subsiding of the cells, as it is the case in charge-related swelling. This in turn allows a particularly uniform and thereby homogeneous force distribution such that the arising contact pressure is applied distributed across the surface to nearly equal extent. Alternatively or additionally, the structural pattern can also be configured such that it plastically deforms upon contact between the at least one structural element and the second wall, whereby a cavity volume of the cavity can be increased, e.g. at least temporarily until further compression of the pad. By such a plastic deformation, an embossed structure can for example be reduced with respect to its structural depth and instead widened. For example, an embossed groove can be pulled into the width by such a plastic deformation, whereby the groove depth decreases. Thus, the embossed structure again approaches to the plane by such a plastic deformation, in which non-embossed surface areas of the first wall are located. The embossed structure is quasi smoothed. By this cavity increase, which is associated with such a plastic and in particular irreversible deformation, pressure can in turn be temporarily relieved in the interior of the cell separating element or the cavity of the pad. Hereby too, a full-surface flattening of the pad can in turn be advantageously avoided in some areas with high swelling pressure. Both by the elastic and by the plastically deformable characteristics, which can begin when the at least one structural element contacts the opposing second wall, a flat contact between the two walls can be advantageously avoided, without therein having to provide some kind of hard stop, which would result in a hard swelling limitation, which would in turn be disadvantageous for the lifetime of the cells.

In addition, these advantageous characteristics can be realized by a certain structural pattern of the cell separating element embossed into at least the first wall. Thus, additional, separate components are not required and the cell separating element can be manufactured in particularly simpler and more efficient manner. For example, the structural pattern can be introduced while the first wall with its shell-shaped shape is formed. In other words, the shell-shaped forming of the first wall and introducing the structural pattern into the first wall can be effected in a same production step, for example by means of deep-drawing and/or embossing. Therein, a temporally successive manufacture or formation of the shell structure and the structural pattern is also conceivable.

Apart from that, the second wall can also be similarly configured as described above and below to the first wall. In other words, thus, the second wall can also be optionally formed with such a structural pattern. Therein, it is particularly advantageous, as it will be explained in more detail later, if the second wall comprises a structural pattern, which is mirror-symmetric to the structural pattern of the first wall.

The walls of the cell separating element, in particular at least one of the walls or both walls, can be formed shell-shaped. Therein, the first wall and/or the second wall can be respectively formed with an elevation or convex bulge opposite to each other in the pad area. Thereby, the cavity between the two walls is provided in the central pad area. For example, the two walls can be realized by two deep-drawn plates or foils. They can be configured deep-drawn opposite to each other in their respective central areas such that a cavity is formed in the central area between the two walls. It is also conceivable that one of the walls is flatly formed and only the other one with a corresponding shell-shaped geometry.

For example, the pad can be configured such that such a fluid, generally a liquid and/or a gas such as for example air, is permanently enclosed in the cavity. However, it can also be configured capable of being passed by such a fluid. For this purpose, a coolant supply and discharge connection can for example be provided at the pad. In both cases, it can be accomplished to generate a certain pressure in the cavity by the fluid. If the cell separating element is arranged between two cells, which swell due to their swelling characteristics, the pad can advantageously be at least partially compressed. Thus, the pad is at least partially compressibly formed. With increasing compression, therein, the counterforce generated by the fluid in the cavity can be increased. In particular, the pad can also be elastically deformable, in particular in the state filled with the fluid. Thereby, especially breathing of the cells, i.e. cyclic swelling and subsiding of the cells depending on state of charge, which can also be called charge-related swelling, can be very well compensated for. Thereby, the pad can very well adapt to the cyclic swelling and subsiding of the cells by a corresponding, elastic variation of its thickness. In addition, if a gas is in the cavity of the pad as the fluid, thus, very good thermal insulating characteristics of the cell separating element can in particular be provided hereby. In addition, a thermal runaway of a battery cell, which adjoins to the cell separating element, for example causes heating of the fluid located in the cavity, in particular gas, whereby it expands and can thereby distance the thermal runaway cell from its neighbor cells. Thus, many advantageous characteristics can be advantageously combined in one cell separating element in simpler manner.

In the following, reference is partially made to different directions for simplified description. Therein, they are to be defined as follows: Therein, the cell separating element has a length in a first direction, a width in a second direction and a thickness in a third direction. Therein, the first wall opposes the second wall with respect to the third direction. Therein, the thickness of the cell separating element or of the pad is also defined in the third direction. In an intended arrangement of the cell separating element in a cell stack with multiple battery cells arranged next to each other in stacking direction, which can for example be formed as pouch cells and/or prismatic battery cells, the third direction may also correspond to the stacking direction.

Furthermore, the cell separating element can for example divide into a pad area, which substantially represents the pad itself, and a cell separating element peripheral area surrounding the pad area in closed manner in a circumferential direction, which delimits the pad in and opposite to the first direction and in and opposite to the second direction, wherein the first wall and the second wall are connected in the cell separating element peripheral area, in particular are joined to each other by a fluid-tight connection, i.e. thus by a fluid-tight join connection.

Basically, the pad can have any geometry and for example also be circularly formed. However, the geometry of the pad may be configured to the geometry of the battery cells, between which the pad is to be arranged. Therein, the pad may be arranged between cells, which are formed as pouch cells or prismatic battery cells. These battery cells typically have a substantially rectangular side surface viewed perpendicularly to the stacking direction. Correspondingly, the pad may also have a rectangular geometry. In an intended installation position of the cell separating element in a battery module, the third direction therein corresponds to the stacking direction. Correspondingly, the first wall as well as the second wall or at least the wall sections delimiting the pad each may have a rectangular geometry. Furthermore, the above defined first, second and third directions may be perpendicular to each other. In other words, the first direction may be perpendicular to the second and the third direction as well as the second direction may be perpendicular to the third direction.

Furthermore, it is very advantageous if a length and width of the cell separating element and of the pad are considerably larger than a thickness of the cell separating element or of the pad in the third direction, in particular by at least a factor of 10. Therein, the length and width can be generally several centimeters, while the thickness of the cell separating element or of the pad is e.g. maximally 15 mm or less at the thickest location.

Therein, the thickness of the pad in the third direction can be substantially constant in the uninstalled state of the cell separating element, that is without additional external force application, except for a prevailing ambient pressure corresponding to standard conditions, across the pad, i.e. in the extension in the first and/or second direction, or can for example vary in the extension in the first and/or second direction.

The cell separating element peripheral area can include a first peripheral area of the first wall, which surrounds the first central area of the first wall and delimits the first wall on both sides with respect to the first and the second direction. In addition, the cell separating element peripheral area can include a second peripheral area of the second wall, which surrounds a second central area of the second wall and delimits the second wall on both sides with respect to the first and the second direction. In other words, the first and the second wall can thus also each be divided into a central area and a peripheral area surrounding this central area in closed manner, which delimits the concerned wall both in the first direction and in the second direction on both sides.

If a fluid is enclosed in the pad or the cavity thereof, or if the pad is passed by a fluid in the operation, thus, the pad can have a compressed and an uncompressed state, wherein the fluid in the cavity in the uncompressed state can have a positive pressure with respect to an ambient pressure or can have a pressure, which corresponds to an ambient pressure or a normal pressure in predetermined standard conditions. In the compressed state of the pad, the fluid in the cavity has an increased pressure with respect to an ambient pressure.

Optional connections, for example a coolant supply connection and a coolant discharge connection, can be arranged in the cell separating element peripheral area of the cell separating element. Hereby, an additional cooling function of the cell separating element can be provided. However, it is particularly advantageous if the pad is configured such that the fluid is enclosed in the cavity of the pad. In this case, the pad does not have to be provided with connections. The fluid can be enclosed in the cavity during the manufacture of the pad. Thereby, the pad does not have to be provided with interfaces for subsequent filling of the cavity with a fluid. Thus, it is very advantageous if the cavity of the pad is filled with a fluid, for example a liquid and/or a gas, and the two walls are fluid-tightly joined in the cell separating element peripheral area by the closed circumferential join connection. Thus, the first peripheral area of the first wall can be fluid-tightly joined to the second peripheral area of the second wall in closed circumferential manner. Thus, the join connection can be realized along a closed circumferential join contour in this case.

The pad can e.g. be permanently filled with a gas as the fluid. Such a gas-fluid pad has the great advantage as the cell separating element that thereby accurately adjustable pressure conditions can be provided as a counterforce of the cell, perfect elastic characteristics can be provided over the lifetime by the gas filling, additionally, very good insulating characteristics can be provided by the gas buffer between the cells. Furthermore, an additional expansion of the gas buffer in the pad upon thermal runaway of a cell can effect an even better insulation by the volume increase of the gas as a result of the high temperature increase, and thus pressing the hot cell away from the cells to be protected can be achieved. Thus, a safety mechanism in case of thermal runaway of a battery cell can be additionally integrated by the gas-filled pad.

Therein, an area is to be understood by a closed circumferential cell separating element peripheral area, which extends along a closed peripheral contour, e.g. around a center of the respective and second wall related to the first and the second direction. In case of a rectangular pad or in case of rectangular sidewalls, the closed circumferential cell separating element peripheral area is correspondingly also rectangular. In case of a round pad, for example, the cell separating element peripheral area would correspondingly also be round. Therein, the cell separating element peripheral area can include a periphery or an edge of the concerned wall, for example the upper and lower as well as also the left and the right periphery of the first wall and the second wall, respectively, but does not have to be restricted to this periphery, but can extend towards the center of the concerned wall to certain extent. For example, the cell separating element peripheral area and correspondingly also the first and the second peripheral area of the respective two walls can extend towards the center starting from the periphery of the respective wall by a length, which may also be only a few millimeters, for example maximally 30 millimeters or maximally 20 millimeters or maximally 10 millimeters.

In an example, the first and the second wall further directly adjoin to the cavity delimited by them. In addition, the cavity is exclusively delimited by areas of the first and the second wall. A pad peripheral area, which circumferentially delimits the pad or the cavity perpendicularly to the third direction, is correspondingly also provided by areas of the first and/or the second wall, namely by the areas, which are located between the cavity and the environment of the pad viewed perpendicularly to the third direction. Thus, the pad peripheral area adjoins to the cavity perpendicularly to the third direction and surrounds it, and the cell separating element peripheral area in turn circumferentially adjoins to the pad peripheral area viewed perpendicularly to the first direction. In particular, the first and the second wall can be the only constituents of the cell separating element. In particular the pad thereby does not have further elements delimiting the cavity.

In an example, the cavity may be a contiguous cavity. Alternatively, the cavity can also be divided into individual partial spaces, which are separated from each other or not fluidically connected to each other. In intended arrangement of the cell separating element between the two battery cells, a major part of the clearance between the two battery cells is e.g. filled with the pad area of the cell separating element, which includes the cavity as the only cavity of the pad area. Thus, the pad area or the cavity may not be divided or separated into individual smaller cavities.

By the join connection, this cavity can be hermetically closed. The walls are inherently also airtightly or gas-tightly formed and do not comprise, at least if the pad is formed as a pressure pad filled with the fluid, in which the fluid is permanently accommodated and enclosed in the cavity, an interface or valves or the like, to supply gas or another fluid to the pad or discharge it from it, at least not without impairing the function of the pad or destroying it. Filling the cavity with the fluid can thus be effected already before or during the joining operation for joining the two peripheral areas of the first and the second wall, and does not have to be effected afterwards.

In particular, the structural pattern can be configured such that if the pad is not compressed or compressed such that the at least one structural element does not have contact with the inner side of the second wall, it is not deformed or substantially not deformed, in particular neither elastically nor plastically. In other words, it is very advantageous if such a deformation of the at least one structural element (significantly) begins only if or earliest if the structural element comes into contact with the inner side of the second wall. However, it can also be that such a deformation also begins already earlier by the swelling pressure.

Furthermore, it is very advantageous if the structural pattern is configured such that it is both elastically deformable and plastically deformable if the at least one structural element has contact with the inner side of the second wall, such that the cavity volume of the cavity increases by the plastic deformation. Therein, the elastic and/or plastic deformation can begin at the same time or also offset in time. In particular, the portion of the respective type of deformation can also change in the temporal course. For example, after contact with the inner side of the second wall, the elastic deformation can first begin or dominate and the plastic deformation can gradually begin or dominate upon even more severe compression of the pad.

In addition, it is conceivable that the structural pattern comprises only a single structural element. It can be configured such that the above described elastic and plastic deformation characteristics are realized in a same structural element. However, the structural pattern can also include multiple structural elements. They can each have the above described elastic and plastic deformation characteristics. However, it can also be provided that some of the structural elements are only or substantially only elastically deformable and other ones of the structural elements are only or substantially only plastically deformable.

The respective plastic and/or elastic deformation characteristics can be influenced by the geometry of such a structural element and/or by the structural depth. Thereby, many possibilities are advantageously provided to configure a structural element more or less elastically and/or plastically deformable.

According to a further advantageous configuration of the examples of the invention, the at least one structural element is formed such that it is elastically deformable or more severely elastically than plastically deformable below a certain limit pressure and plastically deformable or more severely plastically than elastically deformable above the limit pressure, and/or wherein the structural pattern includes a first structural element and a second structural element as the at least one structural element, which are structured such that the first structural element is substantially elastically deformed below a certain limit pressure and the second structural element is substantially only plastically deformed above the limit pressure.

Therein, it is very advantageous if at low pressures, for example caused by an external force application to the cell separating element on both sides, in particular to the pad, and thereby with first lower compression of the pad by the at least one structural element, substantially only an elastic deformation is caused. If the pressure and thereby the compression of the pad further increases, thus, this situation can be additionally mitigated by the plastic deformation, which then begins or dominates. In other words, the plastic deformation results in an, in particular irreversible, cavity increase and thereby in turn in a pressure drop. In particular, the elastic deformation of the at least one structural element can also generate a cavity increase, which is again reversed e.g. upon return of the structural element into its initial shape or initial position. Upon cyclic elastic deformation of the structural element, a cyclic cavity increase and decrease can be effected.

According to a further advantageous configuration of the examples of the invention, the structural pattern comprises a third structural element and a fourth structural element as the at least one structural element, wherein the third structural element is stiffer than the fourth structural element. In other words, the structural pattern can be formed with structural elements of different stiffness. Therein, the third and the fourth structural element can be other structural elements than the structural elements mentioned above, which have been referred to as first and second structural element, or the same. In addition, the at least one third and fourth structural element can be provided additionally or alternatively to the first and the second structural element. In particular, the structural pattern can also include a structural element, which is stiff such that it is not deformable and in particular either is not plastically deformed at the swelling pressures on the cell separating element typically arising in a battery module. By such a structural element, a spacer can be advantageously provided. If the structural element comes to abut on the inner side of the second wall, a further compression of the pad is no longer possible in this area. Thereby, a certain minimum distance between the two walls, at least in wall areas, in which the structural element is not located, can advantageously always be ensured.

According to a further advantageous configuration of the examples invention, the structural pattern comprises a fifth structural element and a sixth structural element as the at least one structural element, wherein the fifth structural element is less deeply embossed than the sixth structural element. The two structural elements can also be the above mentioned first and second and/or third and fourth structural elements or other structural elements. In addition, the at least one fifth and sixth structural element can be provided additionally or alternatively to the first and second and/or third and fourth structural element. By a differently deep embossment of structural elements, it can be accomplished that one of these structural elements, presently the sixth structural element, first comes into contact with the second wall upon compression of the pad with respect to the third direction. Only upon further compression of the pad, the fifth structural element also comes into contact with the opposing second wall. Thereby, a gradual support of the first wall on the second wall can be achieved without providing a full-surface contact between the inner side of the first wall and the inner side of the second wall. If the fifth and the sixth structural element additionally have different elastic characteristics, for example if the fifth structural element is predominantly plastically deformable, while the sixth structural element is predominantly elastically deformable, thus, it can also be accomplished by the differently deep configuration of these structural elements that the elastically deformable characteristics of the structural pattern can first be used upon a compression of the pad and also the plastic deformation characteristics only upon further compression.

Therein, the depth of a structural element is measured with respect to an outer side surface of the first wall. Thus, the structural depth indicates how far such a structural element protrudes towards the second wall starting from the surface of the first wall in non-depressed areas of the first wall.

According to a further advantageous configuration of the examples of the invention, the cell separating element, in particular as already above defined, has a length in a first direction, a width in a second direction and a thickness in a third direction, wherein the pad includes a central area and at least one outer area with respect to the first and/or second direction, wherein the structural pattern is deeper embossed in the central area than in the at least one outer area. With respect to its structural depth, the structural pattern can thereby advantageously also be adapted to the swelling pressures typically acting in different areas of the pad on it. This is in turn based on the realization that battery cells typically more severely bulge or expand in the central area of their side surfaces than in peripheral areas. Thereby, more pressure with respect to the third direction is typically also exerted on the cell separating element in the central area of the pad related to the first and second direction than in peripheral areas or generally the at least one outer area of the pad. In that the structural pattern is deeper embossed in the central area than in the at least one outer area, a greater counterforce can also be opposed to this more severe compression of the pad in the central area, e.g. in that the elastically and/or plastically deformable characteristics are more severely developed in the central area.

Therein, the central area of the pad can include a center of the pad with respect to the first direction and/or second direction. Therein, the at least one outer area can be farther away from this center in and/or opposite to the first direction and/or in and/or opposite to the second direction than the central area. The outer area can adjoin to the central area, but which does not necessarily have to be the case. The outer area can also completely encompass the central area. The pad can for example be divided into the central area and the outer area. Therein, the peripheral area of the pad or the shell periphery is not meant with the outer area, which delimits the pad in and opposite to the first direction as well as in and opposite to the second direction. The wall section of the first wall, which is in the central area of the pad, as well as the wall section of the first wall, which is in at least one outer area of the pad, delimit the cavity of the pad in and opposite to the third direction, respectively.

The structural depth of the structural pattern can for example gradually or continuously increase starting from the central area to the outside, that is perpendicularly to the third direction to the outside.

According to a further advantageous configuration of the examples of the invention, the second wall comprises an embossed depressed second structural pattern with at least one embossed depressed further structural element, which directly opposes the at least structural element of the first wall, in particular such that a distance of the first wall to the second wall between the at least one structural element of the first wall and the further structural element of the second wall in the cavity is locally minimum, in particular except for the pad peripheral area, in which the first and the second wall are joined to each other. Therein, the second wall cannot only comprise a single further structural element, but also multiple further structural elements, as they have in particular already been described to the first wall. Thus, the further structural element can correspond to the at least one structural element of the structural pattern of the first wall, in particular to the first and/or second and/or third and/or fourth and/or fifth and/or sixth and/or the below mentioned seventh and/or eighth structural element of the structural pattern of the first wall. Therein, the second wall may be formed mirror-symmetrically to the first wall with respect to the formation of its second structural pattern. However, only some of the structural elements of the second wall can also be formed mirror-symmetrically to those of the first wall. The second wall can also comprise more or less structural elements than the first wall.

In that the at least one further structural element directly opposes the at least one structural element in the first wall, it can be accomplished that upon contact of the at least one structural element of the first wall with the inner side of the second wall, this contact is established with the further structural element of the second wall. Other areas of the first and the second wall, in which such structural elements or depressions are not located, thereby have a greater distance to each other in the third direction with identical structural depth of the at least one structural element and the at least one further structural element. Conversely, for providing a certain distance between the two walls in non-structured wall areas, the structural elements of the first and the second wall, which correspond to each other, can be with a correspondingly lower structural depth. Thereby, the above mentioned characteristics can be implemented even more efficiently and especially even more installation space saving. In addition, this involves even more flexibility with respect to the different possibilities of formation of the structural elements for achieving certain elastically and/or plastically deformable characteristics.

According to a further advantageous configuration of the examples of the invention, the structural pattern comprises at least one seventh structural element as the at least one structural element, which represents an elongated groove-shaped depression, in particular wherein the structural pattern comprises multiple groove-shaped depressions forming a grid structure as seventh structural elements, which divide the first wall into multiple segments, in particular rectangular segments, in the pad area. For example, some or multiple of these groove-shaped depressions, which are also simply referred to as grooves in the following, can extend elongated in the first direction and some of these grooves can extend elongated in the second direction, in particular rectilinearly. Thereby, these grooves cross each other, in particular at a right angle, and form a corresponding grid structure. Thereby, the first wall is divided into multiple segments, in particular rectangular segments, in the pad area. The rectangular segments can be square. Especially by such a segmentation, a very advantageous, flat, extensive deformation of the cell separating element can be achieved such that the contact pressure arising therein is applied distributed across the surface to identical extent. This is very advantageous in particular in combination with a formation of the adjoining battery cells, which comprise a cell housing, which is for example configured with a circumferential groove structure or ribbing on the housing side facing the cell separating element, such as for example described in DE 10 2020 107 303 A1. Such a groove can also be referred to as bead. Therein, the groove can basically have any cross-sectional geometry, for example a round cross-sectional geometry or else a cornered cross-sectional geometry, for example a triangular or quadrangular cross-sectional geometry. By such a groove pattern, not only the good swelling compensation characteristics described above can be provided, but also a stiffening of the walls of the pad can be achieved at the same time.

According to a further advantageous configuration of the examples of the invention, the structural pattern comprises at least one eighth structural element as the at least one structural element, which represents a local embossment, which comprises a center, which defines a deepest location of the embossment, wherein the embossment includes an area, which encompasses the center and in which a depth of the embossment decreases with increasing distance from the center. By such an embossment, especially a local supporting location can be particularly advantageously provided. Supporting locations e.g. serve for securing a minimum distance of the inner sides of the walls in the area of the cavity in the pressed state of the pad. Thus, this can be realized by embossed structures in the starting material, e.g. in the foils or plates providing the walls, wherein the embossed structures then contact each other in the pressed state and thereby prevent further compression. In addition, such an embossment can be implemented with elastically deformable characteristics as well as additionally or alternatively with plastically deformable characteristics. For example, the embossment can be configured such that it operates in the elastic range at relatively low pressure application and plastically deforms upon more severe pressure applications or with more severe compression of the pad. Hereby, the structural depth, in particular the depth of the center, can decrease, whereby the cavity volume irreversibly increases. Already a small reduction of the structural depth of this embossment already results in a very great volume increase of the cavity volume. Thereby, it can be particularly efficiently counteracted a compression of the pad and the swelling of the battery cells can be particularly efficiently absorbed. In the elastic range too, the depth of the center can temporarily decrease and again increase, whereby herein too the volume increase of the cavity can be used in a temporary compression to relieve the pressure in the cell separating element and to oppose a particularly uniform counterforce to the adjoining battery cells.

According to a further advantageous configuration of the examples of the invention, the structural pattern includes multiple embossments, wherein at least one or exactly one of the embossments is arranged in a respective segment. The segments can be provided by the above described groove pattern. Thus, it is particularly advantageous if the structural pattern includes both the grid structure formed of the groove-shaped depressions and multiple embossments, of which exactly each one may then be arranged in the center or in the middle of such a segment,. Therein, the groove pattern or the respective grooves can represent structural elements, which are stiffer than the embossments. For example, a spacer can be provided by the groove pattern. The groove pattern can be configured such that a plastic deformation of the groove pattern or of the grooves can also occur from a certain limit pressure, but which does not necessarily have to be the case. By the embossments, an elastic deformation can be caused at least first, that is upon low pressure applications, and optionally a permanent volume increase of the cavity can additionally be caused by a plastic deformation upon more severe pressure applications. If an even more severe compression of the pad then occurs, thus, a corresponding minimum distance is ensured by the groove-shaped depressions. The embossments can, in particular in an uncompressed state of the pad, be embossed deeper than the grooves, or the grooves can alternatively also be embossed deeper than the embossments.

Therein, the seventh and/or eighth structural element can be other structural elements than the above mentioned structural elements, which have been referred to as first, second, third, fourth, fifth and sixth structural element, or they can correspond to one or more of them. In addition, the at least one seventh and/or eighth structural element can be provided additionally or alternatively to the above mentioned structural elements.

Furthermore, the cell separating element can have further advantageous features, as they are described e.g. in the co-pending applications of the same applicants, filed at the German Patent and Trademark Office at the same day as the present application, entitled “Cell separating element with integrated cooling channel, battery module, battery and method for producing a cell separating element,” patent application no. DE 10 2024 109 571.7;” “Cell separating element with integrated spacer, battery module and method for producing a cell separating element,” patent application no. DE 10 2024 109 557.1;” and “Cell separating element with mount, battery arrangement and method for producing a cell separating element”, patent application no. DE 10 2024 109 554.7,” for example, respectively in claims 1 to 10 of the co-pending applications, and which contents of the co-pending applications are incorporated by reference herein.

An outer side at least of the first wall can be formed with a first depression in the central pad area, which can in particular be optionally provided by one of the above mentioned grooves, and which includes a first end and a second end, which each join into a shell periphery of the pad. Thus, the depression can be formed as a first structure embossed into the first wall, in particular as a groove, e.g. linearly extending groove. Thereby, the grooves can also take over a further function, namely a cooling function. The second wall can be correspondingly formed. The first wall can comprise multiple such grooves, they can extend parallel to each other and/or intersect each other at an angle, e.g. perpendicularly, and form a groove grid. With respect to the intended installation position in a cell stack, between the first outer side and a cell wall of a battery cell of the battery module adjoining to the first outer side, a cooling channel capable of being passed by a coolant is formed by the depression of the first outer side, through which a coolant, e.g. air, can be conveyed.

In particular, the cell separating element peripheral area can comprise a structure, which is formed by at least one reshaping of the cell separating element peripheral area and by which a spacer supporting with respect to the third direction is provided, in at least one section of the cell separating element peripheral area. The structure extends along the circumferential direction, e.g. over the entire cell separating element peripheral area or only over one or more partial areas of the cell separating element peripheral area, in particular over two partial areas, which are opposing each other with respect to the first direction or with respect to the second direction. The structure can be formed such that a pressure relief and/or stabilization of the join connection is provided by it in case of force application to the pad on both sides from the outside with respect to the third direction, in particular wherein the structure is formed such that the first and the second wall are pressed onto each other in a pressing area of the cell separating element peripheral area upon force application to the spacer on both sides with respect to the third direction, wherein the join connection is in the pressing area, and/or the pressing area is closer to the central pad area than the join connection. The join connection can also be closer to the central pad area than the pressing area. The reshaping of the cell separating element peripheral area can be provided by bending and/or beveling and/or crimping at least one section of the first and/or second peripheral area, in particular by oppositely bending and/or beveling and/or crimping the first and the second peripheral area facing away from each other. The reshaping of the cell separating element peripheral area can also be provided by an embossment of the first and/or second wall in the cell separating element peripheral area, in particular by a mirror-symmetric embossment structure in the first and the second peripheral area. The first and/or the second peripheral area can also be formed with a corrugation structure and/or bead structure and/or groove structure, in particular as the structure or in addition to the structure. Furthermore, at least the first peripheral area can be formed with an elongated first elevation convexly with respect to the third direction, which completely or partially extends around the first central area of the first wall in the circumferential direction, wherein an elastic groove is in particular between the first central area of the first wall and the first elevation, in particular wherein the second peripheral area is additionally formed with an elongated second elevation convexly with respect to the third direction, which directly opposes the first elevation with respect to the third direction, and which completely or partially extends around the second central area of the second wall in the circumferential direction, wherein a further elastic groove is in particular located between the second central area of the second wall and the second elevation.

Alternatively or additionally, it is conceivable that a first part of the first peripheral area is formed as an attachment flap and is arranged angled at an angle to a second part of the first peripheral area adjoining to the pad area and situated in a pad plane of the pad, such that when the pad area of the cell separating element is arranged on a first housing side of a prismatic battery cell, the first part of the first peripheral area can be placed on a second housing side of the battery cell to provide a mount. By the second part of the first peripheral area, an attachment flap can be provided. The cell separating element can be retained on the battery cell in force-fit and/or form-fit manner by it. This flap can extend across the entire width of the second housing side or only across a narrow partial area of it. It can extend across the entire width of the second housing side or only across a part in the third direction. The flap can be formed with a locking element for complementarily coupling or locking to a locking element of the cell housing. The flap can include a spacing element on the end side protruding beyond the second cell side in the third direction. The spacing element can comprise a coupling and/or locking mechanism for coupling or locking into a further coupling or locking element of a further similar cell separating element. The cell separating element can include multiple such flaps, in particular on different sides of the pad, in particular on opposing sides, e.g. with respect to the first and/or second direction. The flap is formed integrally with one or both walls of the cell separating element and is provided by reshaping, e.g. bending.

Furthermore, the examples of the invention also relate to a battery module with a cell separating element according to the examples of the invention or one of its configurations.

For example, the battery module can include a cell stack with multiple battery cells arranged next to each other in a stacking direction. For example, the battery cells can be formed as lithium-ion cells or with any other cell chemistry. For example, the battery cells can be formed as prismatic battery cells and/or pouch cells. Moreover, the battery cells can be in wrap or stack technology, that is with an electrode arrangement in the cell interior, which is an electrode wrap or as a layered or stacked electrode arrangement. The cell stack can for example include at least one first battery cell and at least one second battery cell, which are arranged adjacent to each other in stacking direction and between which a cell separating element according to the examples of the invention may be located. It can be arranged in the clearance between a first and a second battery cell. Therein, the cell separating element can in particular be arranged contacting on the cell walls of the battery cells arranged adjacent from the cell separating element in and opposite to the stacking direction. The cell stack can also include more than two battery cells, wherein a cell separating element according to the examples of the invention can be arranged between each two battery cells arranged adjacent to each other in stacking direction.

Apart from that, the battery module can be formed as already described in context of the cell separating element according to the examples of the invention or its execution examples.

In particular, the cell separating element is clamped in the cell stack such that it is applied with a corresponding force on both sides over the in particular flatly adjoining battery cells, which results in a partial compression of the cell separating element.

In addition, a cooling channel capable of being passed by a coolant can be formed between the first outer side of the cell separating element and a cell wall of a battery cell of the battery module adjoining to the first outer side by the at least one embossed structural pattern, in particular in the form of the groove, of the first outer side. Thus, an outer cooling for cooling the battery cells adjoining to the cell separating element can be advantageously provided by the groove formed in the first outer side. The heat dissipation from the battery cells is thereby considerably improved. The coolant can be a liquid coolant or also a gaseous coolant. For example, the coolant can be air.

Furthermore, the examples of the invention relate to a battery with a battery module according to the examples of the invention or one of its configurations. The battery can be formed as a low-voltage battery, medium-voltage battery or high-voltage battery. The battery can also include multiple battery modules according to the examples of the invention or battery modules according to execution examples of the invention.

Moreover, the battery can be applied in a motor vehicle, but also in other areas outside of a vehicle, for example be formed as a stationary battery or be used in a battery-operated product, for example electric tools, and so on.

Furthermore, the examples of the invention also relate to a motor vehicle with a battery according to the examples of the invention or one of its configurations.

The motor vehicle according to the examples of the invention may be configured as an automobile, in particular as a passenger car or truck, or as a passenger bus or motorcycle.

Furthermore, the examples of the invention also relate to a method for producing a cell separating element for thermally shielding two battery cells and for arrangement between the two battery cells of a battery, wherein the cell separating element is manufactured with a first wall and a second wall opposing it, between which a cavity filled or fillable with a fluid is formed, whereby a pad filled or fillable with the fluid is provided, wherein the first and the second wall are flexibly formed such that a thickness of the pad is variable from the outside upon force application to the pad. Furthermore, a structural pattern with at least one embossed, depressed structural element is embossed at least into the first wall. Therein, the structural pattern is embossed such that when the pad is compressed such that the at least one structural element has contact with an inner side of the second wall adjoining to the cavity, the structural pattern is elastically deformed and/or plastically deformed such that a cavity volume of the cavity increases by the plastic deformation of the structural pattern.

The advantages described for the cell separating element according to the examples of the invention similarly apply to the method according to the examples of the invention.

Developments of the method according to the examples of the invention, which comprise features, as they have already been described in context of the developments of the cell separating element according to the examples of the invention and of the battery module, also belong to the invention. For this reason, the corresponding developments of the method according to the invention are not again described here.

The invention also includes the combinations of the features of the described examples. Thus, the invention also includes realizations, which each comprise a combination of the features of multiple of the described examples if the examples have not been described as mutually exclusive.

### BRIEF DESCRIPTION OF DRAWINGS

In the following, execution examples of the invention are described. Hereto, there shows:

FIG. 1 a schematic cross-sectional representation of a part of a battery module with a cell separating element according to an execution example of the invention; and

FIG. 2 a schematic and perspective representation of a cell separating element according to an execution example of the invention.

### DESCRIPTION

The described execution examples explained in the following are examples of the invention. In the execution examples, the described components of the examples each represent individual features to be considered independently of each other, which each may also develop the examples independently of each other. Therefore, the disclosure also is to include combinations of the features of the examples different from the illustrated ones. Furthermore, the described examples can also be supplemented by further ones of the already described features of the examples of the invention.

In the figures, identical reference characters each denote functionally identical elements.

The illustrated coordinate systems may be cartesian coordinate systems. Therein, the illustrated x-direction corresponds to the previously defined first direction, the illustrated y-direction corresponds to the previously defined third direction and the illustrated z-direction corresponds to the previously defined second direction.

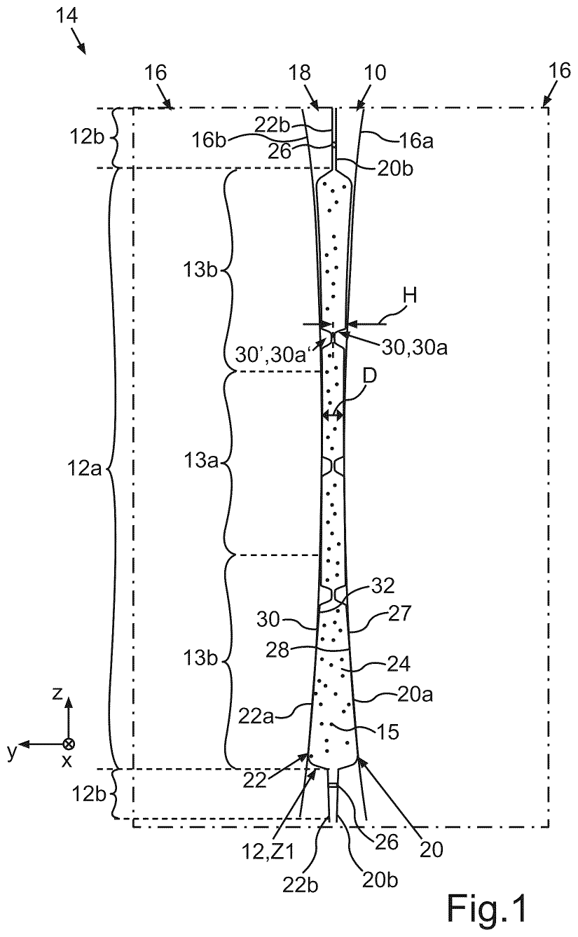

FIG. 1 shows a schematic cross-sectional representation of a part of a battery module 14 with battery cells 16, which are arranged next to each other in a stacking direction y. A part of two of such battery cells 16 is each exemplarily illustrated in FIG. 1, in the clearance 18 of which a cell separating element 10 according to an execution example of the invention is located. Therein, the cell separating element 10 is in particular formed with a pressure pad 12.

In the state illustrated in FIG. 1, the pad 12 is in a partially compressed state Z1. A thickness D of the pad 12 is defined in y-direction, wherein the thickness D can be different in the compressed state Z1 than in the uncompressed state and can also be locally different due to the compressible, in particular elastically compressible characteristics of the pad 12.

For forming the pad 12, the cell separating element 10 includes two shell-shaped walls 20, 22, which each include a central area 20a, 22a and a peripheral area 20b, 22b, which surrounds the central area 20a, 22a in closed circumferential manner. For providing the cavity 24, the walls 20, 22 can be deep-drawn and/or convexly deformed in their respective central area 20a, 22a. The cell separating element 10 includes a pad area 12a, which corresponds to the area, which forms the pad 12, and which includes the central area 20a, 22a of the first and the second wall 20, 22, as well as the cavity 24 formed between these walls 20, 22, which is fillable or filled with a fluid 15. In this example, a fluid 15 is enclosed in the cavity 24. The fluid 15 can for example be a gas. In addition, the cell separating element 10 comprises a cell separating element peripheral area 12b, which surrounds the pad area 12a in closed circumferential manner. Therein, the cell separating element peripheral area 12b includes the first and the second peripheral area 20b, 22b of the respective walls 20, 22. Therein, the two walls 20, 22 are joined to each other in the cell separating element peripheral area 12b via a join connection 26, which is exemplarily a weld seam 26 in this example. Therein, the weld seam 26 extends along a joining line extending in circumferential direction. Thus, the two peripheral areas 22b, 20b of the two walls 20, 22 are joined to each other via the weld seam 26. For example, the two walls 20, 22 can be as separate foils or plates, which are correspondingly fluid-tightly joined to each other by a closed circumferential weld seam 26 as in this example. Alternatively, the walls 20, 22 can also be provided as two halves of a folded or bent plate or foil. In this case, a weld seam 26 according to a U-shaped contour would result.

The first and the second wall 20, 22 each comprise an outer side 27, 30 and an inner side 28, 32. In addition, the first wall 20 is formed with an embossed, depressed structural pattern 30, which comprises at least one embossed, depressed structural element 30a and includes multiple such structural elements 30a in this example. Therein, these structural elements 30a are depressed starting from the outer side 27 of the first wall 20 towards the inner side 28 thereof. Thus, an elevation is formed on the inner side 28 at corresponding location. The structural depth H can be measured starting from a non-embossed location of the wall 20, which adjoins to the structural element 30a, up to the deepest point of the structural element 30a, as schematically illustrated in FIG. 1 for one of the structural elements 30a.

Optionally, the second wall 22 can be mirror-symmetrically to the first wall 20, in particular with respect to the described structural pattern 30. In particular, the second wall 22 can also include a structural pattern 30′ with corresponding structural elements 30a′. In this example, the structural elements 30a′ of the second wall 22 are positioned such that they directly oppose the structural elements 30a of the first wall 20 with respect to the y-direction. This has the great advantage that the structural elements 30a of the first wall 20 first come into contact with the structural elements 30a′ of the second wall 22 upon increasing compression of the pad 12. By suitable dimensioning of the structural elements 30a, 30a′ with respect to size, structural depth H and geometry, numerous advantageous functions can be provided hereby: Hereby, a support function can be provided on the one hand. It for example prevents extensive meeting of the respective inner side 28, 32 of the two walls 20, 22, which would be disadvantageous since the thermal resistance of the cell separating element 10 would hereby considerably decrease, since a direct extensive contact between the two metallic walls 20, 22 would then exist. By the structural elements 30a, 30a′, the walls 20, 22 can be formed with higher stiffness, which also has advantages when the walls 20, 22 are not yet in contact in the area of the cavity 24. It is also particularly advantageous if these structural elements 30a, 30a′ are formed such that, when they are in contact with each other, as presently illustrated, an additional spring function can be provided by their elastically deformable characteristics. For example, such a spring function would also be able to be provided only by the first structural pattern 30 when the structural elements 30a thereof for example would have direct contact with the inner side 32 of the second wall 22, without the second wall 22 having to be formed with such a structural pattern 30′ and/or without the structural elements 30a′ of the second wall 22 having to directly oppose those in the first wall 20. Generally, a hard stop additionally does not have to be provided by the structural elements 30a, 30a′, but a further compression of the pad 12 with resilient, that is elastically deformable effect can be provided in this example of the elastic formation of the structural elements 30a, 30a′ from the contact with the opposing inner side 28, 32. Thus, as soon as the structural elements 30a, 30a′ come into contact with each other or with other areas of the respectively opposing inner side 32, 28 of the opposing wall 22, 20, an additional spring force can be opposed to an increasing expansion of the cells 16 with respect to the y-direction, which aggravates an increasing compression of the pad 12 and thereby also prevents an extensive contact between the non-embossed inner sides 28, 32. Additionally or alternatively, the structural elements 30a, 30a′ can also be formed such that they can be plastically deformed from a certain pressure force. Thus, if the structural elements 30a, 30a′ are further compressed with respect to the y-direction, thus, a corresponding plastic deformation of the structural elements 30a, 30a′ can also result from it, according to which the structural depth H for example permanently and irreversibly decreases and instead the dimension of the structural elements 30a, 30a′ with respect to the z-direction for example increases. Hereby, it can be achieved that the cavity volume of the cavity 24 increases, in particular permanently increases. Thereby, the fluid pressure of the fluid 15 located in the cavity 24 in turn decreases, at least temporarily, until a further compression of the pad 12 is for example effected. Therein, this plastic deformation can particularly well adapt to the pressure effect and allows a particularly uniform pressure distribution across the adjoining cell sides 16a, 16b.

Moreover, it is also conceivable that the structural patterns 30, 30′ are formed such that the structural depth H of their structural elements 30a, 30a′ is not constant for all of the structural elements 30a, 30a′, but varies in certain areas. In the present example, the pad area 12a is again divided into two partial areas, namely a central area 13a and an outer area 13b, which for example surrounds the central area 13a and correspondingly adjoins to the central area 13a in and opposite to the z-direction as well as optionally additionally also in and opposite to x-direction. For example, the structural elements 30a, 30a′ can have a larger structural depth H in the central area 13a than in the outer area 13b. Thereby, an additional or greater supporting effect can be provided especially in the central area 13a and a greater counterforce, in particular a greater elastic and/or inelastic counterforce, can be opposed to the expansion of the cells 16.

Therein, the previously described possible characteristics of the structural elements 30a, 30a′ do not or not all have to be implemented by the structural elements 30a, 30a′ according to the example illustrated in FIG. 1, which are in particular formed as grooves 30a, 30a′. Generally, such a structural pattern 30, 30′ can include arbitrarily many and/or different or other additional or alternative structural elements, by which one or more or all of the above described possible characteristics can be implemented.

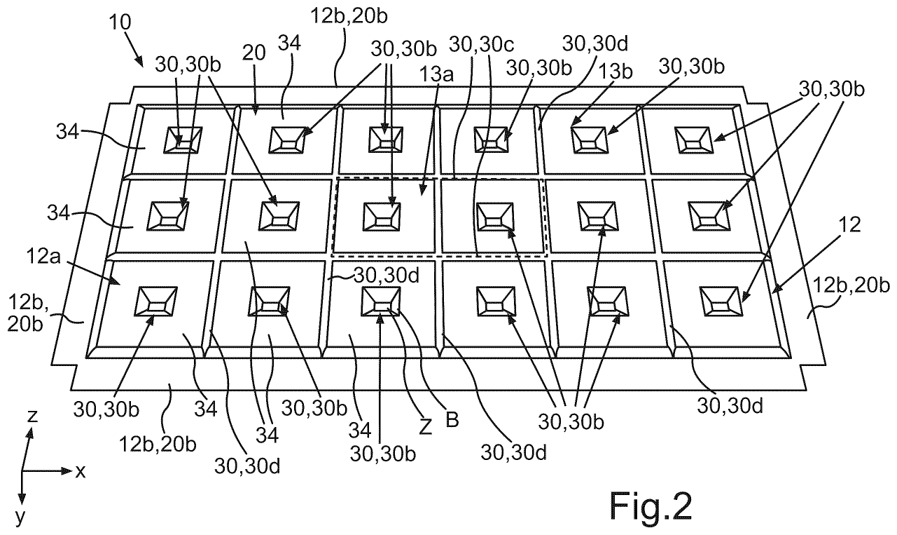

Thus, a respective such structural pattern 30, 30′ can also be formed with differently formed structural elements, which for example also differ with respect to their geometry and/or structural depth H, as it is for example also apparent in FIG. 2. Therein, FIG. 2 shows a schematic and perspective representation of a cell separating element 10 according to an execution example of the invention. It can also be formed as previously described. Herein, in particular only the first wall 20 of the cell separating element 10 is visible, wherein the second wall 22 can be analogously or also differently formed. For example, the second wall 22 can be mirror-symmetrically to the first wall 20. However, the second wall 22 can also be configured merely completely flat and without any embossments or impressions in the pad area 12a. In this example too, the first wall 20 is configured with a structural pattern 30, which includes multiple structural elements 30b, 30c, 30d. Therein, the structural pattern 30 comprises groove-shaped structural elements 30c, 30d on the one hand. groove-shaped structural elements may be elongated grooves 30c, 30d. Therein, the structural pattern 30 includes grooves 30c extending in x-direction on the one hand and grooves 30d extending in z-direction on the other hand, which perpendicularly cross the grooves 30c extending in x-direction. Thereby, the pad surface 32 of the pad 12, in particular the first wall 20, is divided into multiple segments 34, in this example rectangular segments 34, in particular of the same size, in the pad area 12a.

In addition, the structural pattern 30 also includes local embossments 30b as further structural elements 30b. In this example, they are arranged at a respective center of the segments 34. Therein, each embossment 30b includes a center Z, which defines the deepest location of the embossment 30b and which is rectangular in this example. This center Z is enclosed by an area B, which also belongs to the embossment 30b. In this area B, the depth of the embossment 30b decreases with increasing distance from the center Z.

By this structural pattern 30, the same functions can be provided as already described to FIG. 1. For example, the local embossments 30b can be configured such that they are first elastically deformable upon contact of the inner side 32 of the opposing second wall 22 and are plastically deformable at even greater pressures, such that the respective centers Z for example bulge to the outside, that is opposite to the illustrated y-direction, and thereby increase the cavity volume of the cavity 24. The grooves 30c, 30d can take over a spacer and stop function. Then, the grooves 30c, 30d can for example have a lower structural depth H than the local embossments 30b. Additionally or alternatively, the grooves 30c, 30d can for example be stiffer than the local embossments 30b.

In addition, it is conceivable that the local embossments 30b are for example substantially only elastically deformable, while the grooves 30c, 30d are substantially inelastic and are substantially only plastically deformable from a certain pressure application. Numerous other designs are also conceivable.

The grooves 30c, 30d each join into the pad peripheral area of the pad 12 on the end side, which delimits the cavity 24 perpendicularly to the y-direction. Thereby, the grooves 30c, 30d, when the cell separating element 10, as illustrated in FIG. 1, is arranged in a battery module 14 and adjoins to the two cell sides 16a, 16b, can be passed by air, gas or another fluid as needed, e.g. also a liquid. Therein, the structural elements 30a, 30a′ illustrated in FIG. 1 can be formed as such grooves 30c, 30d as they are illustrated in FIG. 2. By the described groove-shaped depressions 30c, 30d and 30a, 30a′, respectively, cooling channels capable of being passed are correspondingly formed between the walls 20, 22 and the cell walls 16a, 16b. They can be correspondingly passed by a coolant to cool or temper the cells 16. The supply and discharge of the cooling medium are modeled in the assembly of the battery. The channel structures 30c, 30d and 30a, 30a′, respectively, allow performing tempering of the cell 16 over the large side surfaces 16a, 16b via a media flow, which is passed between cell housing and cell separating element 10. The present cooling can be thereby replaced or dimensioned smaller and the cooling function can thus be more inexpensively and/or efficiently implemented. In case of a thermal propagation, a portion of the heat can be dissipated via the media flow, whereby the risk of the thermal runaway reduces.

Overall, the examples show, how a pressure pad with integrated plastically and/or elastically deformable contours can be provided by the invention. Hereby, it can be accomplished to integrate certain tasks and functions in the pressure pad without additional components being required hereto. These functions in particular allow a homogenized force distribution and an elastic and/or plastic spring function. The pad can be configured such that it contains structures, which allow a flat extensive deformation of the cell separating element such that the contact pressure arising therein is applied distributed over the surface to equal extent. Such a cell separating element in the form of a steel pad can for example be formed of two shaped half shells. Therein, the half shell geometry can be configured such that it includes additional geometric shapes, namely a structural pattern, which join to each other in the pressed state of the cell separating element. Thereby, a mechanical sheet spring effect occurs in addition to the gas spring effect, which is provided by the fluid located in the cavity. It can be configured such that a specifically elastic as well as plastic deformation can be used to ensure an optimum cell operation over the lifetime. The plastic deformation can consider the non-reversible and the elastic deformation the reversible deformation effects of the battery cells. The elastic elements of the two half shells, that is structural elements, which are substantially only elastically deformable, for example join to each other before the non-elastic elements and locally allow an additional spring force, which is to be overcome to achieve a further compression there. One could also configure all of the structural elements such that they are sufficiently stiffly configured such that a plastic deformation not necessarily occurs therein. The structural elements can also be configured such that either no or intentionally a certain elastic deformation occurs. The development of the geometric structures of the structural elements can be differently intense across the surface of the cell separating element depending on the battery cell behavior. Thus, less intensely developed structures are for example conceivable in the peripheral areas. Therein, the structural depth can be selected depending on the forces to be locally expected and to be compensated for. Parts of such a stainless steel pad, for example internal ribbings, can be such that the parts may go into an elastic-plastic deformation from a defined force, with the target to reduce the maximum force on the cell. Therein, this deformation can thus be either only elastic or only plastic or have both elastic and plastic portions. Therein, parts of the structure can also be permanently elastically deformed and parts of the structure can be elastically-plastically deformed.

Thereby, it can for example be ensured that a minimum distance is complied with, without an additional component being required. Thereby, a further specifically adjustable elastic compression can be realized on the one hand. It can be linearly or also non-linearly adjusted in its development by corresponding geometric configuration of the structures via the pressing distance. In addition, a more uniform distribution of the gas volume is ensured by the structuring of the cell separating element surface, also in case that the force effect is not uniformly or centrally effected. An increased shape stability against position loss in operation load cases and TP (thermal propagation) events can also be provided. For production, a corresponding reshaping tool can be correspondingly configured. The additional effort hereto compared to the today's prior art is considerably compensated for by the lower material cost and the lower weight of the finally produced cell separating element. Therein, stiff geometries, for example dot-shaped or linear depressions, can be introduced into the thin sheet, which provides a wall of the cell separating element, in terms of reshaping technology. Hereto, a translational or rotational reshaping can for example be applied. For reducing the force required hereto, a production concept for low-force reshaping of thin sheet can additionally be employed to thus realize a production concept as inexpensive as possible. The half shells can be shaped such that there are contact surfaces, which have also been referred to as peripheral areas and which can for example be joined by laser welding. Similarly, alternative methods like adhering, folding, crimping, roll bonding methods and so on are conceivable.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. A cell separating element to thermally shield two battery cells of a battery and to be arranged between the two battery cells, comprising:
a first wall and a second wall opposing the second wall, between which the first wall and a second wall a cavity filled or fillable with a fluid is formed to provide a pad filled or fillable with the fluid,
the first wall and the second wall are flexible so that a thickness (D) of the pad is variable from outside upon a pressure application to the pad, and
at least the first wall, among the first wall and the second wall, include a first embossed, depressed structural pattern with at least one first embossed, depressed structural element,
the first embossed, depressed structural pattern, when the pad is compressed such that the at least one first embossed, depressed structural element has contact with an inner side of the second wall adjoining to the cavity, is elastically deformable and/or is plastically deformable such that a cavity volume of the cavity increases by a plastic deformation of the first embossed, depressed structural pattern.

2. The cell separating element according to claim 1, wherein
the at least one first embossed, depressed structural element is elastically deformable or more severely elastically than plastically deformable below a limit pressure, and is plastically deformable or more severely plastically than elastically deformable above the limit pressure, and/or
a structural element and an other structural element, of the at least one first embossed, depressed structural element, are configured such that the structural element is substantially only elastically deformed below a certain limit pressure and the other structural element is substantially only plastically deformed above the limit pressure.

3. The cell separating element according to claim 1, wherein a structural element and an other structural element, of the at least one first embossed, depressed structural element, are configured so that the structural element is stiffer than the other structural element.

4. The cell separating element according to claim 1, wherein a structural element and an other structural element, of the at least one first embossed, depressed structural element, are configured so that the structural element is less deeply embossed than the other structural element.

5. The cell separating element according to claim 1, wherein,
the cell separating element has a length in a first direction (x), a width in a second direction (z) and a thickness (D) in a third direction (y),
the pad includes a central area and at least one outer area with respect to the first direction and/or the second direction (x, z),
the first embossed, depressed structural pattern is embossed deeper in the central area than in the at least one outer area.

6. The cell separating element according to claim 1,
wherein the second wall includes an embossed, depressed second structural pattern with at least one second embossed, depressed structural element, which respectively directly oppose each of the at least one first embossed, depressed structural element of the first wall, such that a distance of the first wall to the second wall between the at least one first embossed, depressed structural element of the first wall and the at least one second embossed, depressed structural element of the second wall in an area of the cavity is locally minimum.

7. The cell separating element according to claim 1, wherein a structural element of the at least one first embossed, depressed structural element is an elongated, groove-shaped depression
the first embossed, depressed structural pattern includes multiple groove-shaped depressions that form a grid structure, which divide the first wall into multiple rectangular segments, in a pad area of the pad.

8. The cell separating element according to claim 1, wherein an embossment of the at least one first embossed, depressed structural element of the at least one first embossed, depressed structural element includes a center (Z), which defines a deepest location of the embossment, wherein the embossment includes an area (B), which encompasses the center (Z) and in which a depth of the embossment decreases with increasing distance from the center (Z).

9. The cell separating element according to claim 7, wherein the at least one first embossed, depressed structural element of the first embossed, depressed structural pattern includes a plurality of embossments, at least one or exactly one embossment among the plurality of embossments is arranged in a respective rectangular segment of the multiple rectangular segments.

10. A battery module with a cell separating element according to claim 1.
